(19) United States
(12) Patent Application Publication
(10) Pub. No.: US 2016/0053787 A1
(43) Pub. Date: Feb. 25, 2016

(54) Utensils for fixing cooking objects

(71) Applicant: Dongjin Du, Irvine, CA (US)

(72) Inventor: Dongjin Du, Irvine, CA (US)

(21) Appl. No.: 14/465,832

(22) Filed: Aug. 22, 2014

(51) Int. Cl. F16B 5/06

(52) U.S. Cl. CPC F16B 5/06

(57) ABSTRACT

The utility model provided for fixing a flat plate in a steam cooking pot or multiple steam cooking pots stacking upward, comprising: an underlying object with lock base(s) as one piece, a locker for each lock base, an upper object. Each locker can be inserted into a lock base and removed by manual easily. The locker(s) can stay inserted at lock base(s) always even when the upper object is being inserted or being taken away. But a locker is difficult to be detached from the lock base without human intervention even it is at open position because of close attachment each other. The utility model can be applied to variable embodiments. E.g., a round cooking pot, a square cooking pot, stackable cooking pots, or a cover of a cooking pot.

### TECHNICAL FIELD

The utility model relates to fixing plate in cooking appliances or multiple cooking pots stacking upward.

### BACKGROUND OF THE INVENTION

Many people prefer to use Micro-waver as food heating device, especially in lunch time of office. As an alternative cooking method, steaming is much better in certain aspects as no boiled water overflow, no browning, preserving food texture/flavour in a more traditional way etc. However, many people does not take steam cooker to office because the steam plate or upper steaming pot are not well fixed with the underlying cooking pot.

Non-well-fixed steam plate inside cooking pot make fetching out cooked food difficult sometimes when food is hot or heavy. Because the food or smaller food container(s) is prone to falling into the hot boiled water when people does not grasp them well.

The utility model is designed for solving above problems.

### DESCRIPTION OF THE PREFERRED EMBODIMENT

The apparatus comprising of locker(s), an under object which has lock base attached to in once piece, and an upper object that can be locked to under object. The under object could be a container only, or an electric heater with cooking container together. The upper object could be an inner plate, or an cooking container with holes of right size and position at the bottom. The locker(s) can be inserted into lock base(s). They can be taken away from the lock base(s) if they are at open position. The upper object can be put on lock base(s) when either locker(s) are not inserted or in open position. If it is put on to lock base(s) when locker(s) are at open position, the locker can be turned into lock position so that the upper object is tied with under object strongly and closely. And the upper object can be taken away from under object only after the locker(s) are turned into open position again.

The upper object is so well fixed to its position relative to the underlying object with locker(s) in lock position that they will not separate each other normally even being unattended in a moving and shaking car, e.g.

### BRIEF DESCRIPTION OF THE DRAWINGS

FIG. 1 contains 4 icons of objects.

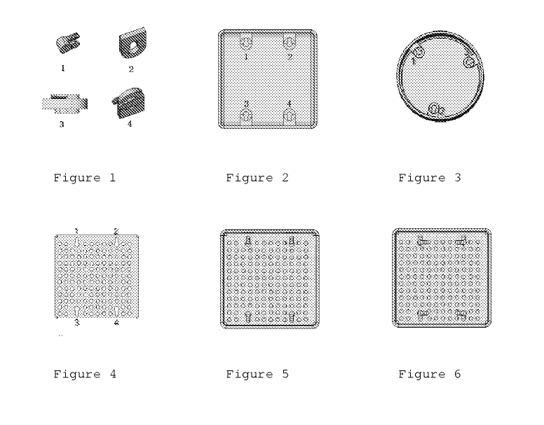

Icon 1.1 is the locker. There are a cylinder base and 2 arms attached to it. The upper arm is longer than the lower arm. And the upper arm's bottom surface is not flat, e.g., round so that the centre part of the arm is thicker than its side part. This shape allow the locker's upper arm to be turned to clip an object of certain thickness.

Icon 1.2 is the lock base. The size of hole just fits the lower arm of the locker(s) to pass through by insertion from top to down.

Icon 1.3 is side view of a locker and a lock base assembled. The locker is inserted into the lock base but in the relative position of open.

Icon 1.4 is side view of a locker and a lock base assembled. The locker is inserted into the lock base and in the relative position of locked.

FIG. 2 is a top view of a square cooking pot with 4 lock bases attached into its inner sides as one piece. It is an example of underlying object.

FIG. 3 is a top view of a round cooking pot with 3 lock bases attached into its inner side as one piece. It is another example of underlying object from FIG. 3.

FIG. 4 is a steam plate with many small holes for steam to pass through and 4 bigger holes for the locker to pass through. The size of a bigger hole fits the upper arm of the locker. It is the upper object for FIG. 2.

FIG. 5 is a top view of assembled model comprising of cooking pot with, steam plate, and lockers. The steam plate is still not locked because the lockers are in open position. By turning each locker to lock position, the steamer plate is fixed to its position.

This is illustrated as FIG. 6.

FIG. 6 is a top view of assembled model comprising same components of FIG. 5. But the steam plate is locked. To take out it from the pot, the lockers have to be turned into open position first.

### ALTERNATE EMBODIMENTS

FIG. 3 shows an alternate embodiment of applying this model to round cocking pot.

Other embodiments are within the following claims.

1. Underlying object has one or more lock base(s) whose size fits the lower arm of locker so that a locker can be inserted into a lock base in open position at any time.

2. A locker can spin from open to lock position with its cylinder part in hole of a lock base so that it is locked when its upper arm is above upper surface of the lock base and its lower arm is below bottom surface of the lock base in lock position.

3. A plate or upper cooking pot to be fixed has holes whose sizes fit the upper arm of lockers so that it can be put above lock bases when lockers being inserted already and but in open position.
